(19) United States
(12) Patent Application Publication
(10) Pub. No.: US 2019/0012412 A1
(43) Pub. Date: Jan. 10, 2019

(54) INFORMATION PROCESSING DEVICE, RECORDING MEDIUM RECORDING MAGNETIC BODY SIMULATION PROGRAM, AND MAGNETIC BODY SIMULATION METHOD

(71) Applicant: FUJITSU LIMITED, Kawasaki-shi (JP)

(72) Inventor: Tomohiro TANAKA, Kawasaki (JP)

(73) Assignee: FUJITSU LIMITED, Kawasaki-shi (JP)

(21) Appl. No.: 16/012,821

(22) Filed: Jun. 20, 2018

(30) Foreign Application Priority Data
Jul. 6, 2017 (JP) 2017-133069

(51) Int. Cl. G06F 17/50

(52) U.S. Cl. CPC G06F 17/5009; G06F 2217/16

(57) ABSTRACT

An information processing device includes: a processor: calculates, for each mesh of a magnetic body, a differential vector between a magnetization vector before a saddle point and a magnetization vector after the saddle point; calculates, as a tangential vector, a component obtained by projecting the differential vector onto a surface; calculates, as a gradient vector, a component obtained by performing projection on the surface with respect to a vector obtained by differentiating energy of the magnetic body; calculates a velocity vector; calculates a fluctuation amount of the magnetization vector, a magnetization vector after the time, and a maximum of the fluctuation amount; resets the magnetization vector after the time to the magnetization vector; calculates a fluctuation amount of the reset magnetization vector, a maximum of the fluctuation amount, and the reset magnetization vector; and outputs information concerning energy of the magnetic body and a magnetization vector at the saddle point.

### CROSS-REFERENCE TO RELATED APPLICATION

This application is based upon and claims the benefit of priority of the prior Japanese Patent Application No. 2017-133069, filed on Jul. 6, 2017, the entire contents of which are incorporated herein by reference.

### FIELD

The embodiment discussed herein is related to an information processing device, a recording medium having a magnetic body simulation program recorded therein, and a magnetic body simulation method.

### BACKGROUND

Magnetic materials are used in a motor of an electric automobile, a memory of a computer, and the like.

Related art is disclosed in International Publication Pamphlet No. WO 2014/033888.

### SUMMARY

According to an aspect of the embodiments, an information processing device includes: a memory; and a processor coupled to the memory, wherein the processor: calculates, for each of meshes corresponding to micro regions of a magnetic body, a differential vector between a magnetization vector before a saddle point in a transition path of a magnetization state of the magnetic body and a magnetization vector after the saddle point; calculates, as a tangential vector, a component obtained by projecting the differential vector onto a surface perpendicular to a magnetization vector of the saddle point; calculates, for each of the meshes, as a gradient vector, a component obtained by performing projection on the surface perpendicular to the magnetization vector of the saddle point with respect to a vector obtained by differentiating energy of the magnetic body at the saddle point with the magnetization vector of the saddle point; calculates, for each of the meshes, based on the tangential vector and the gradient vector, a velocity vector of the saddle point; calculates, for each of the meshes, based on the magnetization vector of the saddle point and the velocity vector of the saddle point, a fluctuation amount in a predetermined time of the magnetization vector of the saddle point, a magnetization vector of the saddle point after the predetermined time, and a maximum of the fluctuation amount in all the meshes; resets, when the maximum is equal to or larger than a threshold, the magnetization vector of the saddle point after the predetermined time to the magnetization vector of the saddle point; calculates a fluctuation amount in the predetermined time of the reset magnetization vector of the saddle point, a maximum in all the meshes of the fluctuation amount, and the reset magnetization vector of the saddle point after the predetermined time; and outputs, when the maximum is smaller than the threshold, information concerning energy of the magnetic body and a magnetization vector of each of the meshes at the saddle point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a micromagnetic simulation;

FIG. 2 illustrates an example of a change in magnetic energy due to transition of a magnetization state;

FIG. 3 illustrates an example of transition of images in a minimum energy path;

FIG. 4 illustrates an example of the minimum energy path and provisionally calculated images;

FIG. 5 illustrates an example of processing executed in a climbing image method;

FIG. 6 illustrates an example of functional blocks of a magnetic body simulation device;

FIG. 7 illustrates an example of processing by the magnetic body simulation device;

FIG. 8 illustrates an example of a magnetic body in which data is allocated to mesh elements;

FIG. 9 illustrates an example of the structure of data output by the magnetic body simulation device;

FIG. 10 illustrates an example of data output by the magnetic body simulation device;

FIG. 11 illustrates an example of a hardware configuration of the magnetic body simulation device;

FIG. 12 illustrates an example of a magnetic body used for confirmation of an effect of the magnetic body simulation device;

FIG. 13 illustrates an example of an initial state and a final state of a transition process of magnetization reversal due to depinning of a magnetic body;

FIG. 14 illustrates an example of comparison of accuracy of an output result of a magnetic body simulation; and

FIG. 15 illustrates an example of an image displayed by the magnetic body simulation device.

### DESCRIPTION OF EMBODIMENT

The performance of a magnetic material might be deteriorated under a high temperature. For example, a loss of information recorded in a memory is sometimes caused by thermal fluctuation under the high temperature. Therefore, optimization of the structure of a device in which the magnetic material is used may be achieved by evaluating and analyzing the performance of the magnetic material with respect to a temperature change.

For example, a string method and a nudged elastic band method (NEB method) are used for the evaluation and the analysis of the performance of the magnetic material. However, a computational amount increases for improvement of accuracy. To reduce the computational amount, a climbing image method is combined with these methods to perform the evaluation and the analysis of the performance of the magnetic material.

For example, in the climbing image method used in the evaluation and the analysis of the magnetic material, physical characteristics of the magnetic material are not taken into account. Therefore, the evaluation and the analysis of the performance of the magnetic material might not be performed at high accuracy. For example, the evaluation and the analysis of the performance of the magnetic material may be performed at high accuracy.

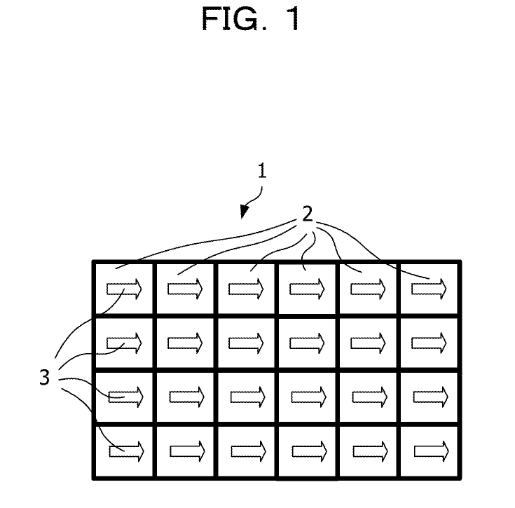

As an example of a method for the evaluation and the analysis of the performance of the magnetic material, a micromagnetic simulation is used. FIG. 1 illustrates an example of the micromagnetic simulation. The micromagnetic simulation is a method of regarding that a magnetic body 1 is divided into micro regions (also described as mesh elements or meshes) 2, disposing micro magnetizations (magnetization vectors) 3 for each of the mesh elements 2, and calculating behaviors of the micro magnetizations 3. As it is seen from FIG. 1, the micro magnetizations 3 represented by arrowed line segments are disposed in a plurality of micro mesh elements 2 of the magnetic body 1. The direction and the orientation of the micro magnetizations 3 sometimes change because of the influence of a temperature change. Consequently, magnetic energy of the magnetic body 1 sometimes changes.

Magnetic energy Eₜₒₜₐₗ [J] of the magnetic body 1 is represented by the following expression.

Eₜₒₜₐₗ=Eₐₙᵢ+E_{exc}+Eₐₚₚₗ+E_{static} (1)

In the expression, Eₐₙᵢ [J], E_{exc} [J], Eₐₚₚₗ [J], and E_{static} [J] respectively represent anisotropic energy, exchange energy, Zeeman energy, and static magnetic field energy.

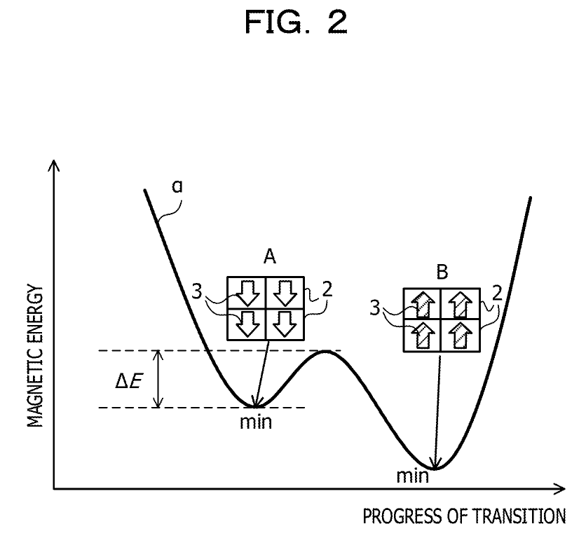

FIG. 2 illustrates an example of a change in magnetic energy due to transition of a magnetization state. In the magnetic body 1, a state corresponding to the direction and the orientation of the magnetization vectors 3 for each of the mesh elements 2 (also described as magnetization state) is present.

The magnetization state of the magnetic body 1 could change according to thermal fluctuation or the like. For example, the magnetic body 1 sometimes transitions from a certain magnetization state to another magnetization state according to the thermal fluctuation or the like. The horizontal axis “Progress of transition” in a graph of FIG. 2 represents a progress degree of the transition of the magnetization state. The magnetic energy Eₜₒₜₐₗ of the magnetic body 1 could change according to the transition of the magnetization state. The vertical axis “Magnetic energy” in the graph of FIG. 2 corresponds to the magnetic energy Eₜₒₜₐₗ. A curve α represents a change in the magnetic energy Eₜₒₜₐₗ involved in a change of a magnetization state of a certain magnetic body 1.

In FIG. 2, two magnetization states A and B are illustrated. Magnetization states are simplified and illustrated as the magnetization states A and B for facilitation of understanding. The magnetization states are not limited to the magnetization states A and B. In FIG. 2, all the magnetization vectors 3 in the magnetization state A are directed downward. All the magnetization vectors 3 in the magnetization state B are directed upward.

On the graph of FIG. 2, the magnetic energy is a minimum (min) in the magnetization states A and B. Therefore, if thermal fluctuation or the like is absent, the magnetization states A and B could be more stable magnetization states than other magnetization states in FIG. 2.

For transition from a certain stable magnetization state to another stable magnetization state, magnetic energy is demanded. For example, in FIG. 2, in a change from the magnetization state A to the magnetization state B, the magnetic body 1 may not transition to the magnetization state B unless the magnetic body 1 obtains magnetic energy of ΔE. In this way, for the transition from a certain magnetization state to another magnetization state, energy that the magnetic body 1 has to obtain is sometimes present as a barrier between the two magnetization states.

The energy functioning as the barrier separating the two stable magnetization states, the energy being energy that the magnetic body 1 obtains to be able to transition from a certain stable magnetization state to another stable magnetization state, is described as maximum energy barrier. In the transition from the magnetization state A to the magnetization state B in FIG. 2, the maximum energy barrier is ΔE.

In general, transition of a magnetization state is sometimes caused by a factor such as thermal fluctuation. The magnetic body 1 stable in a certain magnetization state sometimes increases magnetic energy with heat and transitions to another magnetization state. For example, the magnetic body 1 in the magnetization state A increases the magnetic energy by ΔE or more with heat. According to the increase in the magnetic energy, the magnetization state of the magnetic body 1 could jump over the maximum energy barrier and change. The magnetic body 1 sometimes transitions from the first stable magnetization state A to another stable magnetization state B.

From a magnetization state related to a start of transition (described as initial state as well) to a magnetization state related to an end of the transition (described as a final state as well), one or more patterns (also referred to as paths or transition paths) are present as ways of progress of a change of magnetization states of the mesh elements 2 in the magnetic body 1. A curve α in FIG. 2 corresponds to one of the transition paths. The transition paths are more specifically explained. In FIG. 2, when the magnetization state transitions from the magnetization state A to the magnetization state B, there is a transition path in which the magnetization vectors 3 of the meshes 2 sequentially reverse one by one into the magnetization state B and there is a transition path in which the magnetization vectors 3 sequentially reverse in twos into the magnetization state B. In this way, various energy paths are present according to the ways of the change of the magnetization vectors 3. If the transmission path is different, a value of the maximum energy barrier ΔE separating the magnetization state A and the magnetization state B could also be different. Among the one or more transition paths, a transition path in which the maximum energy barrier separating the initial state and the final state is a minimum is described as minimum energy path.

By deriving the minimum energy path, it is possible to surmise how stable a magnetization state regarded as being stable in a state without thermal fluctuation is when thermal fluctuation occurs and magnetic energy increases. Therefore, it is assumed that a magnetic body simulation device explained below derives the minimum energy path.

In the following explanation, order is given to magnetization states in stages from an initial state to a final state of transition in the minimum energy path. The magnetization states to which the order is given are described as images as well.

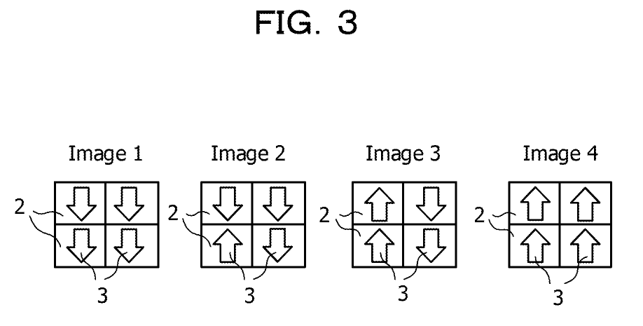

FIG. 3 illustrates an example of transition of the images in the minimum energy path. In FIG. 3, an Image 1 corresponds to the initial state, an Image 4 corresponds to the final state, and an Image 2 and an Image 3 correspond to the magnetization states halfway in progress of the transition. The transition progresses in order of the Image 1, the Image 2, the Image 3, and the Image 4. In the Image 1, all the magnetization vectors 3 in the mesh elements 2 are directed downward. The number of the mesh elements 2 in which the upward magnetization vectors 3 are disposed increases in the Image 2 and the Image 3. In the Image 4, all the magnetization vectors 3 are directed upward.

The string method, the NEB method, or the like is performed to provisionally derive the minimum energy path in advance. Based on the minimum energy path derived using the string method, the NEB method, or the like, maximum magnetic energy (described as maximum energy as well) in the minimum energy path is derived using the climbing image method. If the maximum energy is calculated, a maximum energy barrier is calculated by subtracting magnetic energy of the initial state from the maximum energy. Note that both of the string method and the NEB method are methods for inputting an original system and a generator system in chemical reaction or the like, searching for a reaction path between the original system and the generator system, and calculating transition states and energy of the transition states. The number of images on the minimum energy path obtained by the string method, the NEB methods, or the like (hereinafter described as string method or the like as well) may be smaller than the number of images calculated by the string method or the like when the climbing image method is not used. The number of images obtained by the string method or the like only has to be a degree in which a magnitude relation of magnetic energy in the images in the minimum energy path is seen. The number of images obtained by the string method or the like may be, for example, 1/k (k: natural number) of the images obtained by the string method or the like when the climbing image method is not used.

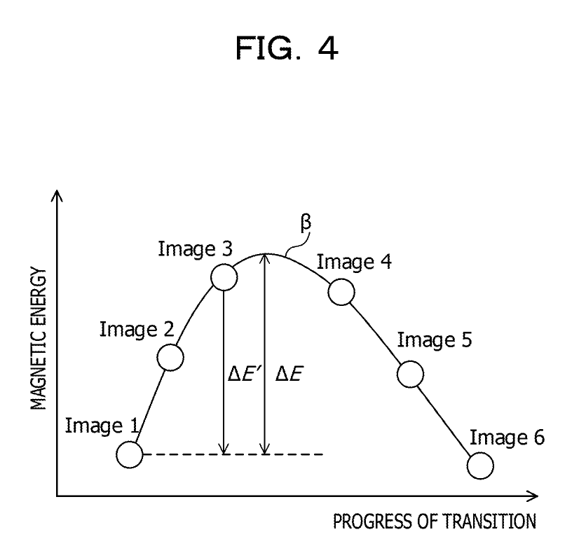

FIG. 4 illustrates an example of the minimum energy path and provisionally calculated images. In FIG. 4, a curve β represents the minimum energy path, and images of an Image 1 to an Image 6 represent magnetization states in the minimum energy path β derived by the string method or the like.

An image in which the magnetic body 1 has maximum magnetic energy among the images excluding both ends (an initial state and a final state) in the minimum energy path β is described as saddle point image as well. A point where a magnetization state of the magnetic body 1 is the saddle point image (for example, a coordinate in “progress of transition” of the saddle point image or a point in time when the magnetization state is the saddle point image) is described as saddle point as well. Images calculated by the string method or the like in advance in FIG. 4 are the images of the Image 1 to the Image 6. In this case, the Image 3 may be surmised as a saddle point image. The images in the minimum energy path β obtained by the string method or the like is discrete. The number of the images is not large. Therefore, maximum magnetic energy in the surmised saddle point image sometimes does not coincide with actual maximum magnetic energy. Therefore, a maximum energy barrier in the minimum energy path sometimes does not coincide with an actual maximum energy barrier, for example, in FIG. 4, the maximum energy barrier is calculated as ΔE′ and is a value different from an accurate maximum energy barrier ΔE.

The climbing image method is a method of inputting information concerning an image surmised as a saddle point image to the magnetic body simulation device and temporally changing the surmised saddle point image along the minimum energy path. Consequently, an actual saddle point image is derived. Note that an image input as the surmised saddle point image may be another image by another result of the string method or the like. Information concerning any image may be input if the image is in the vicinity of an actual saddle point. In the simulation, the surmised saddle point image is temporally changed. A change corresponding to the temporal change is in a positive direction of “progress of transition”. Therefore, a point surmised as the saddle point image is a point before the actual saddle point image in a “progress of transition” axis. However, the point surmised as the saddle point image is not limited to this. For example, when transition of a magnetization state and magnetic energy are temporally irreversible, the point surmised as the saddle point image may be an image after the actual saddle point image in the “progress of transition” axis. The magnetic body simulation device may change the image surmised as the saddle point image in a negative direction of the “progress of transition” along the minimum energy path and derive the actual saddle point image and the maximum magnetic energy.

A time development method for the saddle point image (the actual saddle point image and the image surmised as the saddle point image) derived using the climbing image method is as described below.

$$\begin{matrix}\frac{\partial {\vec{m}}_{j}^{saddle}}{\partial t} = C \{ - {\vec{g}}_{j}^{saddle} + 2 \{ {\sum }_{k}^{N} ( {\vec{τ}}_{k}^{saddle} \cdot {\vec{g}}_{k}^{saddle} ) \} {\vec{τ}}_{j}^{saddle} \} & ( 2 ) \\ {\vec{g}}_{j}^{saddle} = \frac{\partial {E}_{total}}{\partial {\vec{m}}_{j}^{saddle}} & ( 3 ) \\ {\vec{τ}}_{j}^{saddle} = {\vec{m}}_{j}^{saddle + 1} - {\vec{m}}_{j}^{saddle - 1} & ( 4 )\end{matrix}$$

In the above expressions, C indicates a velocity adjustment parameter, N indicates the number of all meshes of the magnetic body 1, and saddle indicates numbers for identifying the images in the minimum energy path (in the example illustrated in FIG. 3, β), indicates natural numbers set in descending order along a direction of transition on the minimum energy path, and indicates a number attached to the actual saddle point or the point surmised as the saddle point. The magnetic body simulation device changes the magnetization state from the point surmised as the saddle point and calculates an image or the like at the actual saddle point. Therefore, first, a number attached to the image surmised as the saddle point image is set in saddle. In the above expressions, j indicates a natural number equal to or smaller than N indicating numbers attached to the mesh elements 2, mⱼ^{saddle} with an arrow “→” attached thereon indicates the magnetization vector 3 disposed in a j-th mesh element 2 in a saddle-th image. Similarly, gⱼ^{saddle} with the arrow “→” attached thereon is an energy gradient vector (described as gradient vector as well) disposed in the j-th mesh element 2 in the saddle-th image. Similarly, τⱼ^{saddle} is a tangential vector (a differential vector between the magnetization vectors 3 before and after the actual saddle point or the surmised saddle point) disposed in the j-th mesh element 2 in the saddle-th image. All of these vectors are three-dimensional vectors. However, the vectors are not limited to this and may be one-dimensional or two-dimensional vectors. In the following explanation, “→” indicating a vector is used in expressions. Description of “→” in other parts is omitted. In the expressions, mⱼ^{saddle}, gⱼ^{saddle}, and τⱼ^{saddle} are respectively functions of a time t and are described as mⱼ^{saddle}(t), gⱼ^{saddle}(t), and τⱼ^{saddle}(t) as well.

In FIG. 4, mⱼ^{saddle} is the magnetization vector 3 in the Image 3. Similarly, mⱼ^{saddle-1} is the magnetization vector 3 of the immediately preceding image when viewed from the surmised saddle point image among the images in the minimum energy path. In the images illustrated in FIG. 4, mⱼ^{saddle-1} is the magnetization vector 3 in the Image 2. Further, mⱼ^{saddle+1} is the magnetization vector 3 of the immediately following image when viewed from the surmised saddle point image among the images in the minimum energy path. In FIG. 4, mⱼ^{saddle+1} is the magnetization vector 3 in the Image 4. The images in the initial state and the final state are the Image 1 and the Image 6 in FIG. 3.

A convergence decision condition of the climbing image method is represented by the following Expression 5.

$${max}_{j ∈ N} \vert {\vec{m}}_{j}^{saddle} ( t + Δ t ) - {\vec{m}}_{j}^{saddle} ( t ) \vert < ɛ \qquad ( 5 )$$

In Expression 5, Δt represents a time pitch and ε represents a convergence threshold. Δt and ε are respectively values designated by a user. The magnetization vectors 3 of the mesh elements 2 in the saddle point image are substituted in ∥ on the left side of Expression 5.

In deriving the maximum magnetic energy using the climbing image method, what is substituted as the magnetization vector mⱼ^{saddle}(t) of the saddle point image first is the magnetization vectors 3 of the mesh elements 2 of the saddle point image surmised by the string method or the like. In the case of FIG. 3, the magnetization vectors 3 of the mesh elements 2 in the Image 3 are substituted in Expression 5 first by the magnetic body simulation device. What is substituted as mⱼ^{saddle}(t+Δt) of Expression 5 is the magnetization vector 3 after Δt of the magnetization vectors 3 of the mesh elements 2 in the surmised saddle point image (for example, the image 3). Note that the magnetization vectors 3 after Δt are calculated by a method explained below.

The left side of Expression 5 derives a maximum magnitude of difference in all the mesh elements 2 among magnitudes of differences between mⱼ^{saddle}(t) and mⱼ^{saddle}(t+Δt). When the derived magnitude of the difference is smaller than ε of the right side of Expression 5, magnetic energy in the saddle point image is regarded as a maximum (or a maximum value) in the minimum energy path. Accordingly, the magnetization vectors 3 of the mesh elements 2 are regarded as having converged. The magnetic body simulation device resets mⱼ^{saddle}(t+Δt) as mⱼ^{saddle}(t) until Expression 5 is satisfied and determines whether Expression 5 is satisfied. When the convergence decision condition represented by Expression 5 is satisfied, the surmised saddle point image may be regarded as coinciding with the actual saddle point image. A saddle point image and magnetic energy in this case are derived.

Further, the climbing image method adapted to physical characteristics of the magnetic body 1 is used. The length of the magnetization vector 3 is physically 1. Therefore, the magnetic body simulation device uses the climbing image method to satisfy the length of the magnetization vector 3.

Because the physical length of the magnetization vector 3 is 1, when starts points of the magnetization vector 3 at respective times are regarded as the same point, points that end points of the magnetization vectors 3 may take are present on the surface of a sphere, the radius of which is 1. A velocity vector ∂mⱼ^{saddle}(t)/∂t of the magnetization vectors mⱼ^{saddle}(t) is physically perpendicular to the magnetization vector mⱼ^{saddle}(t). Therefore, the magnetic body simulation device performs correction such that velocity vector ∂mⱼ^{saddle}(t)/∂t is perpendicular to mⱼ^{saddle}(t) according to such physical characteristics of the magnetization vector 3.

The length of the magnetization vector 3 is kept fixed by the correction. By inputting the magnetization vector 3, the length of which is 1 as an initial value, to the magnetic body simulation device, the length of the magnetization vector 3 is kept at 1.

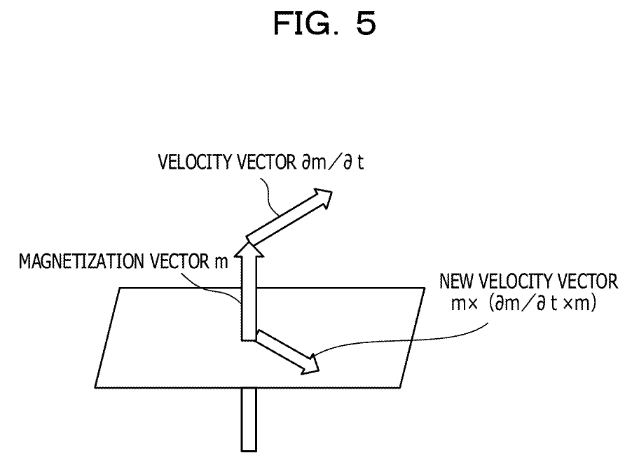

FIG. 5 illustrates an example of processing executed in the climbing image method. The magnetic body simulation device performs the following processing illustrated in FIG. 5 to thereby obtain a velocity vector corrected to be perpendicular to the magnetization vector 3 from a velocity vector used in the existing climbing image method. The magnetic body simulation device according to this embodiment calculates an outer product of the magnetization vector 3 (a “magnetization vector m” in FIG. 5) and the velocity vector (a “velocity vector ∂m/∂t” in FIG. 5) used in the existing climbing image method. The magnetic body simulation device calculates an outer product of the vector (∂m/∂t×m) obtained by the outer product and the magnetization vector 3 (m) and sets, as a new velocity vector, a vector (“m×(∂m/∂t×m)” in FIG. 5) obtained by the outer product. The new velocity vector is perpendicular to the magnetization vector 3.

The magnetic body simulation device performs the following processing to further improve accuracy of calculation. It is seen from Expression 2 that the velocity vector ∂mⱼ^{saddle}(t)/∂t is a sum of vectors obtained by multiplying the gradient vector gⱼ^{saddle} and the tangential vector τⱼ^{saddle} respectively by coefficients. Therefore, the magnetic body simulation device corrects each of the gradient vector gⱼ^{saddle} and the tangential vector τⱼ^{saddle} to be perpendicular to mⱼ^{saddle}, which is the magnetization vector 3, to correct the velocity vector ∂mⱼ^{saddle}(t)/∂t to a vector perpendicular to mⱼ^{saddle}. The magnetic body simulation device performs, as the correction of the gradient vector gⱼ^{saddle} and the tangential vector τⱼ^{saddle}, calculation using the outer product with respect to each of the gradient vector gⱼ^{saddle} and the tangential vector τⱼ^{saddle}. The magnetic body simulation device calculates mⱼ^{saddle}×(gⱼ^{saddle}×mⱼ^{saddle}) and mⱼ^{saddle}×(τⱼ^{saddle}×mⱼ^{saddle}). These vectors are respectively vectors obtained by projecting the gradient vector gⱼ^{saddle} and the tangential vector τⱼ^{saddle} onto a plane perpendicular to the magnetization vector mⱼ^{saddle}. The magnetic body simulation device sets, as a new gradient vector and a new tangential vector, these vectors projected onto the plane perpendicular to the magnetization vector mⱼ^{saddle}. The magnetic body simulation device calculates a velocity vector perpendicular to the magnetization vector mⱼ^{saddle} using each of the new gradient vector and the new tangential vector.

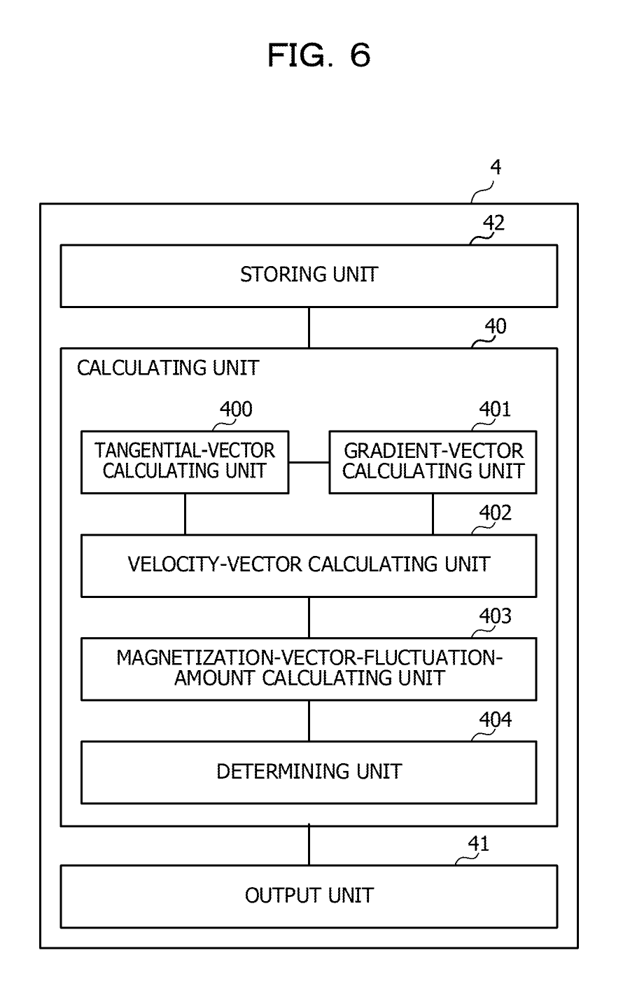

FIG. 6 illustrates an example of a magnetic body simulation device 4. The magnetic body simulation device 4 includes a calculating unit 40, an output unit 41, and a storing unit 42. The magnetic body simulation device 4 may include an input unit. The calculating unit 40 is connected to the output unit 41 and the storing unit 42.

The calculating unit 40 includes a tangential-vector calculating unit 400, a gradient-vector calculating unit 401, a velocity-vector calculating unit 402, a magnetization-vector-fluctuation-amount calculating unit 403, and a determining unit 404. At least one of the tangential-vector calculating unit 400 and the gradient-vector calculating unit 401 is connected to the velocity-vector calculating unit 402. When the gradient-vector calculating unit 401 is connected to the velocity-vector calculating unit 402, the tangential-vector calculating unit 400 is connected to at least one of the gradient-vector calculating unit 401 and the velocity-vector calculating unit 402. It is assumed that the tangential-vector calculating unit 400 is connected to the gradient-vector calculating unit 401 and the velocity-vector calculating unit 402. The magnetization-vector-fluctuation-amount calculating unit 403 is connected to the velocity-vector calculating unit 402 and the determining unit 404.

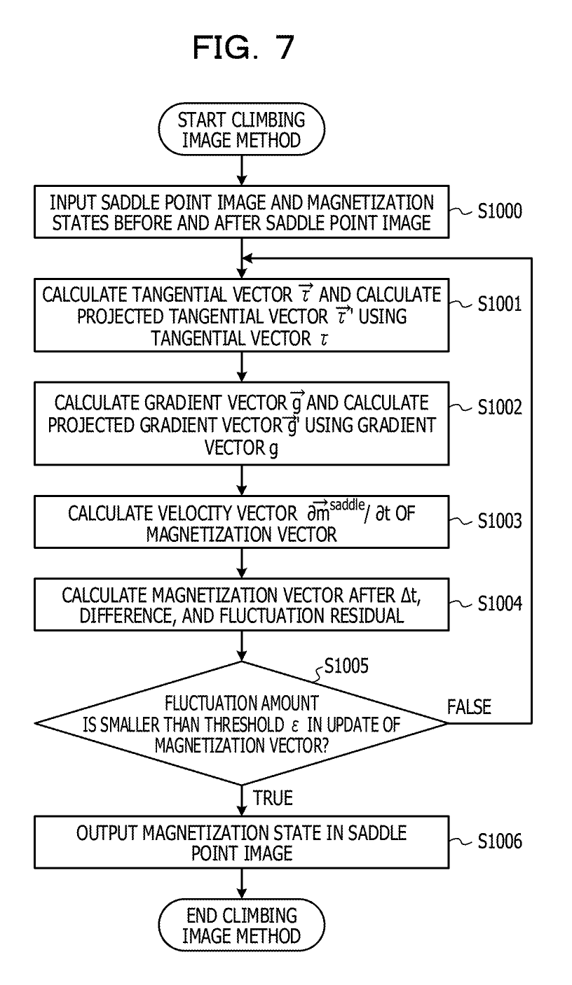

FIG. 7 illustrates an example of processing by the magnetic body simulation device (e.g., the magnetic body simulation device 4). An entity of a flow illustrated in FIG. 7 is not limited to the magnetic body simulation device 4 illustrated in FIG. 6.

The calculating unit 40 acquires data related to each of the magnetization vector mⱼ^{saddle} of a surmised saddle point, the magnetization vector mⱼ^{saddle-1} of an immediately preceding magnetization state of the saddle point, and the magnetization vector mⱼ^{saddle+1} of an immediately following magnetization state of the saddle point (step S1000). Data related to the magnetization vector 3 is described as magnetization vector data as well. Note that the surmised saddle point and the saddle point image are respectively described as saddle point and saddle point image below. Note that, in the step, data input as data before and after the saddle point are not limited to the data of the immediately preceding and immediately following data of the saddle point. For example, for example, mⱼ^{saddle-2} and mⱼ^{saddle+2} may be input instead of mⱼ^{saddle-1} and mⱼ^{saddle+1} input in the step.

It is assumed that the magnetization vector data input to the calculating unit 40 are acquired in advance by the string method, the NEB method, or the like in the past. It is assumed that the data are stored in the storing unit 42.

The calculating unit 40 acquires mesh data indicating how the magnetic body 1 is divided into the mesh elements 2 and data concerning physical property values of the magnetic body 1 (referred to as physical property value data as well). The magnetization vector data, the mesh data, and the physical property value data are also stored in the storing unit 42. The calculating unit 40 acquires these data from the storing unit 42. Note that these data may be input to the magnetic body simulation device 4 from the user or other devices via the input unit.

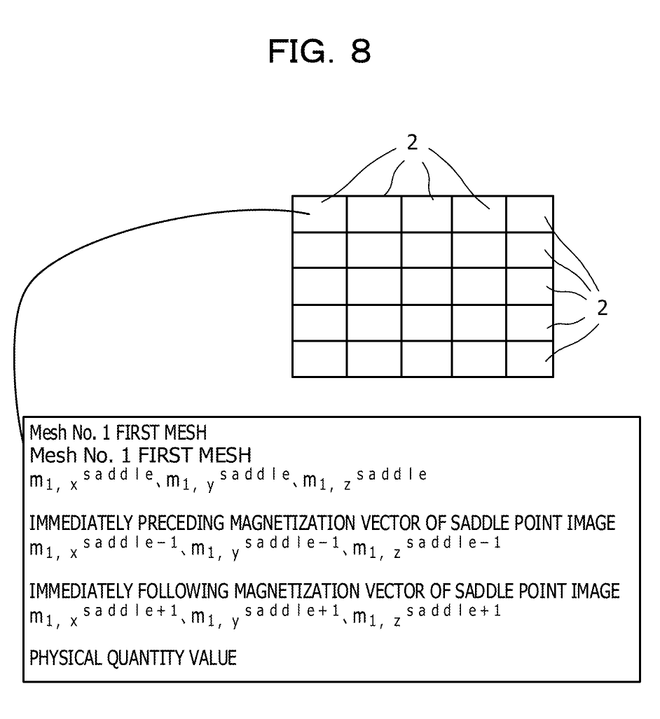

FIG. 8 illustrates an example of the magnetic body 1 in which data is allocated to the mesh elements 2. It is assumed that the allocation of the data to the mesh elements 2 is already performed when the calculating unit 40 acquires the magnetization vector data, the mesh data, and the physical property value data from the storing unit 42. The calculating unit 40 acquires the magnetization vector data, the mesh data, and the physical property value data for each of the mesh elements 2.

In FIG. 8, data allocated to a first mesh element (the mesh element 2 in the uppermost portion at the left end among the mesh elements 2 illustrated in FIG. 8) among the data allocated to the mesh elements 2 is illustrated. As explained below, IDs (Identifiers) are attached to the mesh elements 2. A mesh element, an ID of which is n, is described as n-th mesh element (Mesh No. n) as well. As illustrated in the first mesh element 2 in FIG. 8, x, y, and z components of the magnetization vector 3 of the saddle point image, the magnetization vector 3 of the immediately preceding magnetization state of the saddle point image, and the magnetization vector 3 of the immediately following magnetization state of the saddle point image and the physical property values of the magnetic body 1 are allocated to the mesh elements 2. In FIG. 8, m_{1, x}^{saddle}, m_{1, y}^{saddle}, and m_{1, z}^{saddle} respectively represent an x component, a y component, and a z component of the magnetization vector 3 in the first mesh element 2 of the saddle point image. Similarly, m_{1, x}^{saddle-1}, m_{1, y}^{saddle-1}, and m_{1, z}^{saddle-1} respectively represent an x component, a y component, and a z component of the magnetization vector 3 in the first mesh element 2 of the immediately preceding image of the saddle point image. Further, m_{1, x}^{saddle+1}, m_{1, y}^{saddle+1}, and m_{1, z}^{saddle+1} respectively represent an x component, a y component, and a z component of the magnetization vector 3 in the first mesh element 2 of the immediately following image of the saddle point image.

The tangential-vector calculating unit 400 in the calculating unit 40 stores Expression 4 and the following Expression 6.

\vec{τ}′ⱼ^{saddle}=\vec{m}ⱼ^{saddle}×{(=\vec{m}ⱼ^{saddle+1}−\vec{m}ⱼ^{saddle-1})×\vec{m}ⱼ^{saddle}} (6)

The tangential-vector calculating unit 400 substitutes the input mⱼ^{saddle-1} and mⱼ^{saddle+1} of the mesh elements 2 in Expression 4 and calculates the tangential vector τⱼ^{saddle} of the mesh elements 2 as in the past. In addition to this, the tangential-vector calculating unit 400 substitutes the calculated tangential vector τⱼ^{saddle} (=mⱼ^{saddle+1}−mⱼ^{saddle-1}) and the input mⱼ^{saddle} in Expression 6 to obtain τ′ⱼ^{saddle} (step S1001 in FIG. 7).

The vector τ′ⱼ^{saddle} calculated in step S1001 is a vector obtained by projecting the tangential vector τⱼ^{saddle} onto the plane perpendicular to the magnetization vector mⱼ^{saddle}.

The gradient-vector calculating unit 401 stores Expression 3 and the following Expression 7.

$${\vec{g}}_{j}^{′ saddle} = {\vec{m}}_{j}^{saddle} \times ( \frac{\partial {E}_{total}}{\partial {\vec{m}}_{j}^{saddle}} \times {\vec{m}}_{j}^{saddle} ) \qquad ( 7 )$$

The gradient-vector calculating unit 401 substitutes the input mⱼ^{saddle} of the mesh elements 2 in Expression 3 and calculates the tangential vector gⱼ^{saddle} of the mesh elements 2 as in the past. In addition, the gradient-vector calculating unit 401 substitutes the calculated gradient vector gⱼ^{saddle} (=∂Eₜₒₜₐₗ/∂mⱼ^{saddle}) in Expression 7 and obtains g′ⱼ^{saddle} (step S1002).

The vector g′ⱼ^{saddle} calculated in step S1002 is a vector obtained by projecting the tangential vector gⱼ^{saddle} onto the plane perpendicular to the magnetization vector mⱼ^{saddle}.

Note that the processing in step S1001 and the processing in step S1002 may be performed in order opposite to the order explained above or may be performed in parallel.

The velocity-vector calculating unit 402 is input with τ′ⱼ^{saddle} and g′ⱼ^{saddle}. If the velocity-vector calculating unit 402 is connected to the tangential-vector calculating unit 400 and the gradient-vector calculating unit 401, the velocity-vector calculating unit 402 may acquire τ′ⱼ^{saddle} and g′ⱼ^{saddle} respectively from the tangential-vector calculating unit 400 and the gradient-vector calculating unit 401. The velocity-vector calculating unit 402 may acquire τ′ⱼ^{saddle} and g′ⱼ^{saddle} from one of the tangential-vector calculating unit 400 and the gradient-vector calculating unit 401 to which the velocity-vector calculating unit 402 is connected. For example, when the gradient-vector calculating unit 401 outputs τ′ⱼ^{saddle} and g′ⱼ^{saddle} to the velocity-vector calculating unit 402, the tangential-vector calculating unit 400 calculates τ′ⱼ^{saddle} in advance and outputs τ′ⱼ^{saddle} to the gradient-vector calculating unit 401. The gradient-vector calculating unit 401 outputs τ′ⱼ^{saddle} acquired from the tangential-vector calculating unit 400 and g′ⱼ^{saddle} calculated by the gradient-vector calculating unit 401 to the velocity-vector calculating unit 402.

The velocity-vector calculating unit 402 substitutes the input τ′ⱼ^{saddle} and g′ⱼ^{saddle} in the following Expression 8 and calculates the velocity vector ∂mⱼ^{saddle}/∂t of the magnetization vector mⱼ^{saddle} in the saddle point images of the mesh elements 2 (step S1003 in FIG. 7). The velocity vector ∂mⱼ^{saddle}/∂t calculated here is perpendicular to the magnetization vector mⱼ^{saddle}.

$$\frac{\partial {\vec{m}}_{j}^{saddle}}{\partial t} = C \{ - {\vec{g}}_{j}^{′ saddle} + 2 \{ {\sum }_{k}^{N} ( {\vec{τ}}_{k}^{′ saddle} \cdot {\vec{g}}_{k}^{′ saddle} ) \} {\vec{τ}}_{j}^{′ saddle} \} \qquad ( 8 )$$

In the expression, C is a velocity adjustment parameter designated in advance by the user. ∂mⱼ^{saddle}/∂t calculated in the string image method in the past is not typically perpendicular to mⱼ^{saddle}. In the string image method in the past, τⱼ^{saddle} and gⱼ^{saddle} are substituted in Expression 2 to calculate ∂mⱼ^{saddle}/∂t. However, because both of τⱼ^{saddle} and gⱼ^{saddle} are not typically perpendicular to mⱼ^{saddle}, the obtained ∂mⱼ^{saddle}/∂t is not typically perpendicular to mⱼ^{saddle} either.

The magnetization-vector-fluctuation-amount calculating unit 403 acquires the velocity vector ∂mⱼ^{saddle}/∂t of the magnetization vectors 3 in the saddle point images of the mesh elements 2 from the velocity-vector calculating unit 402. The magnetization-vector-fluctuation-amount calculating unit 403 calculates time development of the magnetization vector mⱼ^{saddle} using the input velocity vector ∂mⱼ^{saddle}/∂t.

The magnetization-vector-fluctuation-amount calculating unit 403 retains mⱼ^{saddle} (put as mⱼ^{saddle}(t)), which is the magnetization vector 3, input from the storing unit 42 in step S1000. The magnetization-vector-fluctuation-amount calculating unit 403 calculates the magnetization vector 3 after elapse of a predetermined time Δt (put as mⱼ^{saddle}(t+Δt)) using mⱼ^{saddle}(t) and ∂mⱼ^{saddle}/∂t (step S1004). A numerical integration method such as a Euler method or a Runge Kutta method is used for the calculation. The calculation may be performed using implicit integration besides explicit integration. The magnetization-vector-fluctuation-amount calculating unit 403 calculates a difference between mⱼ^{saddle}(t) and calculated mⱼ^{saddle}(t+Δt) (step S1004). The difference corresponds to a change during Δt of the magnetization vector 3 in the saddle point image. Note that changes in Δt of the x component, the y component, and the z component of the magnetization vector 3 are collectively described as fluctuation amount. However, the fluctuation amount of the magnetization vector 3 is not limited to the fluctuation amount in the x, y, and z components and may be, for example, a fluctuation amount in γ, θ, and φ components of a polar coordinate. The magnetization-vector-fluctuation-amount calculating unit 403 derives a maximum absolute value of the fluctuation amount (described as maximum residual as well) in all the mesh elements 2 (step S1004). Note that the maximum residual corresponds to the left side in Expression 5. The magnetization-vector-fluctuation-amount calculating unit 403 outputs the derived maximum residual to the determining unit 404.

The determining unit 404 stores the convergence threshold ε and determines whether the maximum residual input from the magnetization-vector-fluctuation-amount calculating unit 403 is smaller than the convergence threshold ε, that is, whether the input maximum residual satisfies Expression 5 (step S1005).

When the maximum residual does not satisfy Expression 5 (step S1005: FALSE), the determining unit 404 resets mⱼ^{saddle}(t+Δt) calculated in the magnetization-vector-fluctuation-amount calculating unit 403 as new mⱼ^{saddle}(t). The calculating unit 40 returns the processing to step S1001 and performs the same processing as the processing explained above. Therefore, mⱼ^{saddle}(t) and the like used for the calculation in step S1004 and the like are reset here.

When the maximum residual satisfies Expression 5 (step S1005: TRUE), the output unit 41 outputs, based on an instruction from the calculating unit 40, magnetization vector data (data related to mⱼ^{saddle}(t)) in the saddle point image (step S1006).

After the processing in step S1006, the magnetic body simulation device 4 ends the processing.

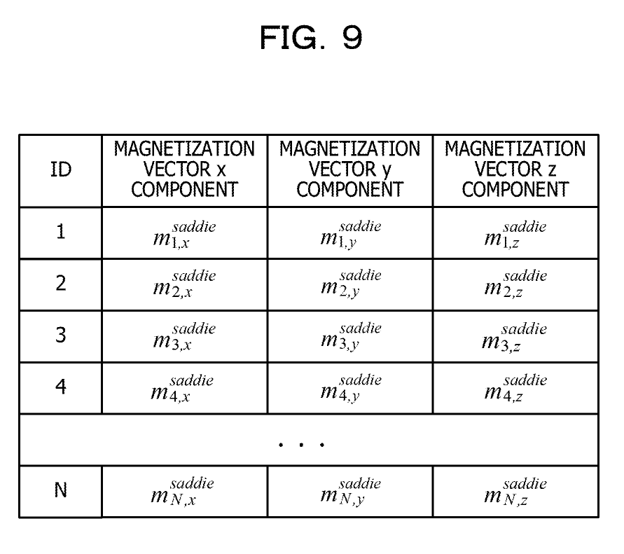

FIG. 9 illustrates an example of the structure of the data output by the magnetic body simulation device 4 in step S1006. IDs of the mesh elements 2 and x, y, and z components of the magnetization vectors 3 corresponding to the IDs are output. In FIG. 9, m_{j, x}^{saddle}, m_{j, y}^{saddle}, and m_{j, z}^{saddle} respectively represents an x component, a y component, and a z component of the magnetization vector 3 in the saddle point image in the j-th mesh element.

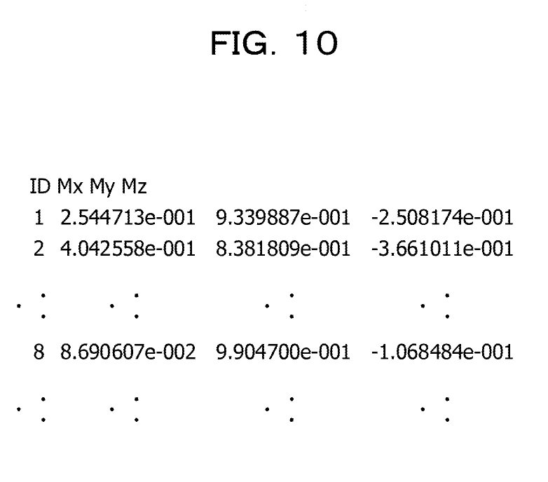

FIG. 10 illustrates an example of the data illustrated in FIG. 9. In FIG. 10, it is seen that, for example, an x component (Mx in FIG. 10) of the magnetization vector 3 in a first mesh element, an ID of which is 1, is indicated as “2.544713e-001” by exponential notation and is 2.544713×10⁻¹. The same applies to values of components of the other magnetization vectors 3.

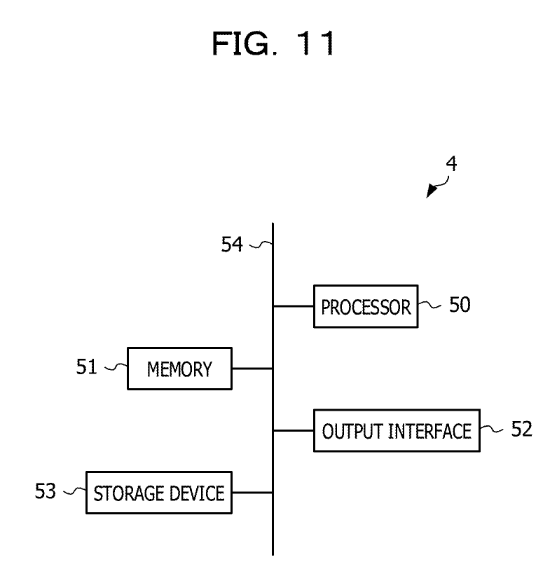

FIG. 11 illustrates an example of a hardware configuration of the magnetic body simulation device 4. The magnetic body simulation device 4 includes a processor 50, a memory 51, an output interface 52, and a storage device 53. The magnetic body simulation device 4 may include an input device. The devices included in the magnetic body simulation device 4 are connected by a bus 54 or the like.

The processor 50 is, for example, a single-core, dual-core, or multi-core processor.

The memory 51 is, for example, a read only memory (ROM), a random access memory (RAM), or a semiconductor memory. The data input in step S1000 of the flow explained with reference to FIG. 7 is read into the memory 51 from the storage device 53. The memory 51 stores the data such as ε, Δt, C, and the expressions. The memory 51 stores various programs for the processing of the processor 50.

The processor 50 executes a program using the data stored in the memory 51, whereby the function of the calculating unit 40 is realized. That is, the program describes, for example, the processing of the flowchart illustrated in FIG. 7. The processor 50 executes the program, whereby the functions of the tangential-vector calculating unit 400, the gradient-vector calculating unit 401, the velocity-vector calculating unit 402, the magnetization-vector-fluctuation-amount calculating unit 403, and the determining unit 404 illustrated in FIG. 6 are realized.

The output interface 52 is an interface for the magnetic body simulation device 4 to output data to a devise served for design and the like of an apparatus in which a magnetic material is used (described as design device as well) and a display device such as a liquid crystal display served for confirmation by the user. The function of the output unit 41 is realized by the output interface 52.

The storage device 53 is, for example, a hard disk drive or an optical disk device and may be an external storage device or a portable storage medium. The function of the storing unit 42 is realized by the storage device.

When the magnetic body simulation device 4 includes an input device, the input device is, for example, an input interface and a communication device that acquires information from a keyboard, a mouse, a touch panel, and other devices connected to the magnetic body simulation device 4 by the input interface. The function of the input unit is realized by the input device.

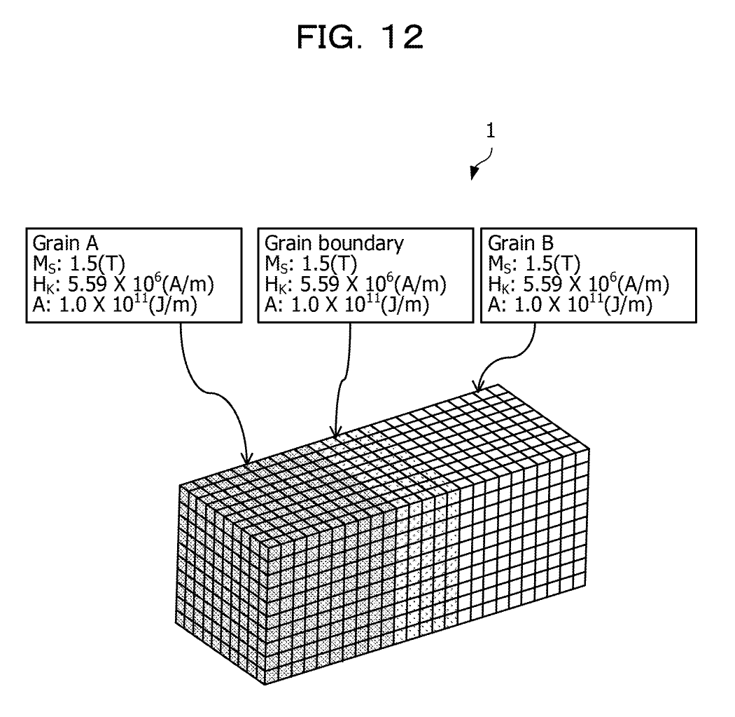

An effect obtained when the magnetic body simulation is performed is explained. First, a model of the magnetic body 1 set as a target of the simulation are illustrated in FIG. 12. In the magnetic body 1 before the simulation, three regions are present as illustrated in FIG. 12. Calculation of a maximum energy barrier before and after transition of a magnetization state is performed on such a magnetic body 1. A maximum energy barrier in a transition process in which the magnetization vector 3 in the magnetic body 1 reverses according to depinning of the magnetic body 1 is calculated. In FIG. 12, a Grain A and a Grain B at both ends of the magnetic body represent a main layer. A Grain boundary present in the middle of these layers represents a grain boundary layer. In the following explanation, the Grain A and the Grain B are respectively referred to as main layer A and main layer B as well. The Grain boundary is referred to as grain boundary layer as well. Mₛ, Hₖ, and A illustrated in FIG. 12 are respectively equivalent to saturation magnetization, an anisotropic magnetic field, and an exchange coupling constant. For example, in the main layer A, the saturation magnetization is 1.5 [T], the anisotropic magnetic field is 5.59×10⁶ [A/m], and the exchange coupling constant is 1.0×10¹¹ [J/m]. Note that, in this verification, calculation of static magnetic field energy is omitted.

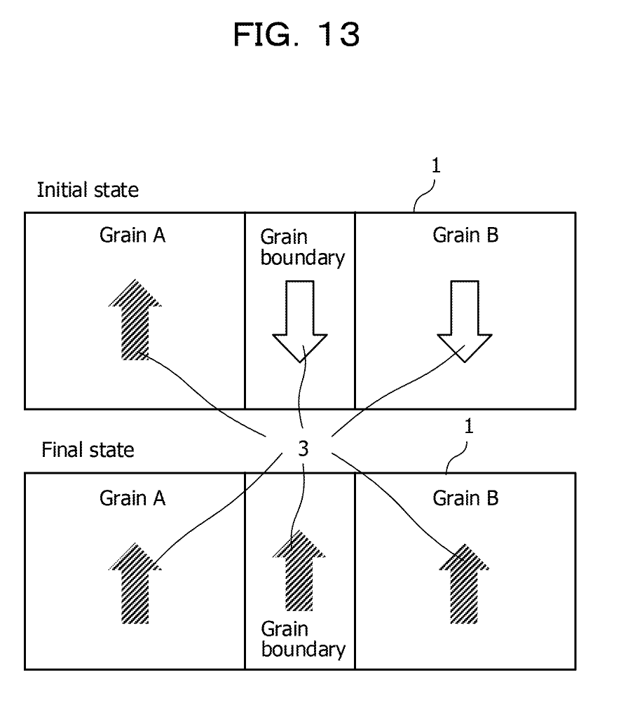

FIG. 13 illustrates an example of an initial state and a final state of a transition process of magnetization reversal by depinning of the magnetic body 1. Arrows in layers illustrated in FIG. 13 represent directions of the magnetization vectors 3 in the layers. For example, the magnetization vector 3 in the main layer A in the initial state is directed upward.

In the initial state illustrated in FIG. 13, the magnetization vector 3 of the main layer A is directed upward. With the grain boundary layer as a boundary, the magnetization vectors 3 of the grain boundary layer and the main layer B are fixed (pinned) downward. When an external magnetic field of 1.0×10⁶ [A/m] is applied to the magnetic body 1 in the upward direction in FIG. 13, release of the pinning (depinning) occurs in the grain boundary layer and the main layer B. In the final state, the magnetization vectors 3 in these layers are directed upward.

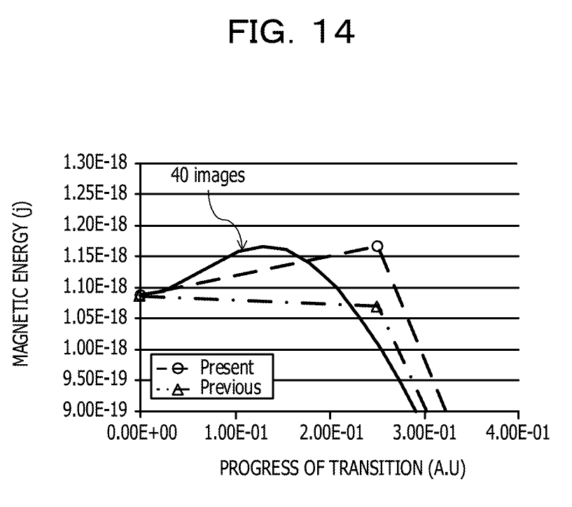

FIG. 14 illustrates an example of comparison of accuracy of an output result of the magnetic body simulation. In FIG. 14, the horizontal axis corresponds to a progress degree of transition of a magnetization state and the vertical axis corresponds to the magnetic energy Eₜₒₜₐₗ of the magnetic body 1. In FIG. 14, a solid line graph attached with explanation “40 Images” indicates a minimum energy path by forty images calculated by the string method. In FIG. 14, a broken line graph marked “Previous” indicates a minimum energy path calculated by calculating a minimum energy path by five images with the string method in advance and applying, with the minimum energy path set as input data, the climbing image method in the past to the input data.

In FIG. 14, a broken line graph marked “Present” indicates a minimum energy path calculated by calculating a minimum energy path by five images with the string method in advance and applying, with the minimum energy path set as input data, the climbing image method to the input data.

As illustrated in FIG. 14, the maximum energy barrier obtained when the magnetic body simulation method with a small number of images (five) is used is close to a maximum energy barrier obtained by calculating a large number of images (forty) with the string method. An absolute error of the maximum energy barrier obtained by the magnetic body simulation method was 6.9×10²³ [J] and a relative error of the maximum energy barrier was 0.0059%.

As illustrated in FIG. 14, in the magnetic body simulation method (Previous), a wrong result indicating absence of an energy barrier is derived. It is seen from this that accuracy of derivation of a minimum energy path and a maximum energy barrier is improved from the accuracy in the past by the magnetic body simulation method (Present). In the magnetic body simulation method (Previous), standardization of magnetization in every repetition and discontinuation of the climbing image method by setting of an upper limit number of times of repetition are performed. The standardization of magnetization for every repetition represent that, because the length of the magnetization vector 3 is not limited to 1 when the magnetic body simulation method (Previous) is used, the length is set to 1, for example, every time the time development of the magnetization vector 3 is calculated. The discontinuation of the climbing image method by the setting of the upper limit number of times of repetition represents that processing is discontinued, for example, when the convergence condition indicated by Expression 5 is not satisfied and the processing is repeated many times.

With the magnetic body simulation device 4, a physical characteristic of the magnetization vector 3 (the length of the magnetization vector 3 is 1) is considered and measures for setting the velocity vector and the like perpendicular to the magnetization vector 3 is taken such that the characteristic is satisfied. By performing the calculation considering the physical properties of the magnetization vector 3 in this way, it is possible to reduce the number of images to be used and reduce a computational amount and calculate the maximum energy barrier in the minimum energy path of the magnetic body 1 at high accuracy. Consequently, in design of an apparatus in which a magnetic material is used, it is possible to highly accurately perform evaluation and analysis of the performance of the magnetic material while reducing a computational amount.

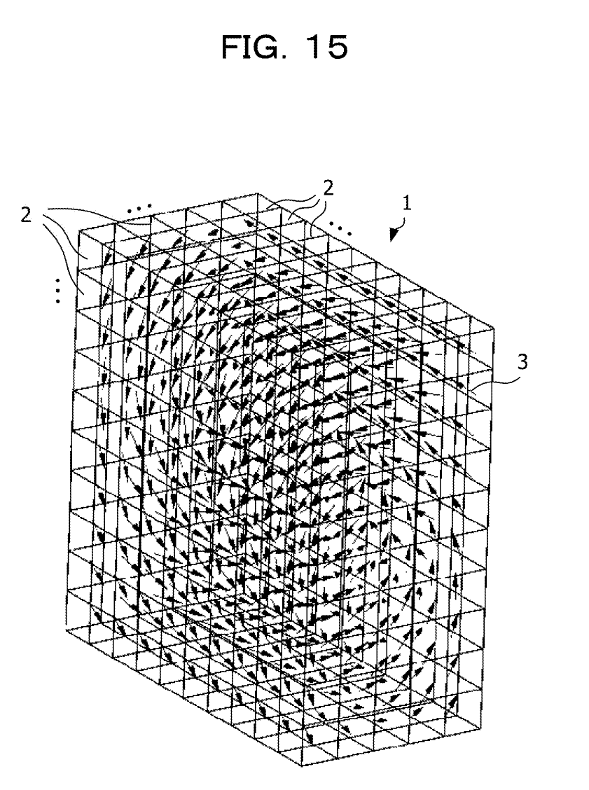

With the magnetic body simulation device 4, further, it is possible to perform display of magnetization states of the meshes 2 at the saddle point to be visually recognizable. FIG. 15 illustrates an example of an image displayed by the magnetic body simulation device 4. Note that an image representing a simulation result illustrated in FIG. 15 is displayed on the display device (the output unit 41 in FIG. 6).

Besides numerically representing the magnetization states as illustrated in FIGS. 9 and 10, the magnetic body simulation device 4 may display the magnetization vectors 3 of the meshes 2 at the saddle point as images as illustrated in FIG. 15. In this case, the mesh data acquired by the magnetic body simulation device 4 from the storing unit 42 in step S1000 (FIG. 7) explained above includes information in which the IDs of the meshes 2 and each of the x, y, and z coordinates in the magnetic body 1 are associated. For example, x, y, and z coordinates associated with an n-th mesh 2 indicate a coordinate of the n-th mesh. The magnetic body simulation device 4 disposes the magnetization vectors 3 in the meshes 2 of the magnetic body 1 using the data illustrated in FIGS. 9 and 10 obtained by the calculation and the mesh data and generates the image illustrated in FIG. 15. Arrows arranged in the meshes 2 in FIG. 15 represent the magnetization vectors 3. By using the image illustrated in FIG. 15, it is possible to more easily perform design of a motor of an electric automobile, a memory of a computer, and the like including magnetic materials.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a memory; and
a processor coupled to the memory, wherein
the processor:
calculates, for each of meshes corresponding to micro regions of a magnetic body, a differential vector between a magnetization vector before a saddle point in a transition path of a magnetization state of the magnetic body and a magnetization vector after the saddle point;
calculates, as a tangential vector, a component obtained by projecting the differential vector onto a surface perpendicular to a magnetization vector of the saddle point;
calculates, for each of the meshes, as a gradient vector, a component obtained by performing projection on the surface perpendicular to the magnetization vector of the saddle point with respect to a vector obtained by differentiating energy of the magnetic body at the saddle point with the magnetization vector of the saddle point;
calculates, for each of the meshes, based on the tangential vector and the gradient vector, a velocity vector of the saddle point;
calculates, for each of the meshes, based on the magnetization vector of the saddle point and the velocity vector of the saddle point, a fluctuation amount in a predetermined time of the magnetization vector of the saddle point, a magnetization vector of the saddle point after the predetermined time, and a maximum of the fluctuation amount in all the meshes;
resets, when the maximum is equal to or larger than a threshold, the magnetization vector of the saddle point after the predetermined time to the magnetization vector of the saddle point;
calculates a fluctuation amount in the predetermined time of the reset magnetization vector of the saddle point, a maximum in all the meshes of the fluctuation amount, and the reset magnetization vector of the saddle point after the predetermined time; and
outputs, when the maximum is smaller than the threshold, information concerning energy of the magnetic body and a magnetization vector of each of the meshes at the saddle point.

2. The information processing device according to claim 1, wherein the transition path is a minimum energy path.

3. The information processing device according to claim 1, wherein the processor displays, on a display device, the information concerning the energy of the magnetic body and the magnetization vector of each of the meshes at the saddle point.

4. The information processing device according to claim 3, wherein the processor displays, as an image, the magnetization vector of each of the meshes at the saddle point.

5. The information processing device according to claim 1, wherein
the information processing device is coupled to a design device, and
the processor outputs, to the design device, the information concerning the energy of the magnetic body and the magnetization vector of each of the meshes at the saddle point.

6. A non-transitory computer-readable recording medium recording a magnetic body simulation program which causes a computer to perform a process, the process comprising:
calculating, for each of meshes corresponding to micro regions of a magnetic body, a differential vector between a magnetization vector before a saddle point in a transition path of a magnetization state of the magnetic body and a magnetization vector after the saddle point;
calculating, as a tangential vector, a component obtained by projecting the differential vector onto a surface perpendicular to a magnetization vector of the saddle point;
calculating, for each of the meshes, as a gradient vector, a component obtained by performing projection on the surface perpendicular to the magnetization vector of the saddle point with respect to a vector obtained by differentiating energy of the magnetic body at the saddle point with the magnetization vector of the saddle point;
calculating, for each of the meshes, based on the tangential vector and the gradient vector, a velocity vector of the saddle point;
calculating, for each of the meshes, based on the magnetization vector of the saddle point and the velocity vector of the saddle point, a fluctuation amount in a predetermined time of the magnetization vector of the saddle point, a magnetization vector of the saddle point after the predetermined time, and a maximum of the fluctuation amount in all the meshes;
resetting, when the maximum is equal to or larger than a threshold, the magnetization vector of the saddle point after the predetermined time to the magnetization vector of the saddle point;
calculating a fluctuation amount in the predetermined time of the reset magnetization vector of the saddle point, a maximum in all the meshes of the fluctuation amount, and the reset magnetization vector of the saddle point after the predetermined time; and
outputting, when the maximum is smaller than the threshold, information concerning energy of the magnetic body and a magnetization vector of each of the meshes at the saddle point.

7. The non-transitory computer-readable recording medium according to claim 6, wherein the transition path is a minimum energy path.

8. The non-transitory computer-readable recording medium according to claim 6, further comprising:
displaying, on a display device, the information concerning the energy of the magnetic body and the magnetization vector of each of the meshes at the saddle point.

9. The non-transitory computer-readable recording medium according to claim 8, wherein the processor displays, as an image, the magnetization vector of each of the meshes at the saddle point.

10. The non-transitory computer-readable recording medium according to claim 6, further comprising:
outputting, to a design device, the information concerning the energy of the magnetic body and the magnetization vector of each of the meshes at the saddle point.

11. A magnetic body simulation method, comprising:
calculating, by a computer, for each of meshes corresponding to micro regions of a magnetic body, a differential vector between a magnetization vector before a saddle point in a transition path of a magnetization state of the magnetic body and a magnetization vector after the saddle point;
calculating, as a tangential vector, a component obtained by projecting the differential vector onto a surface perpendicular to a magnetization vector of the saddle point;
calculating, for each of the meshes, as a gradient vector, a component obtained by performing projection on the surface perpendicular to the magnetization vector of the saddle point with respect to a vector obtained by differentiating energy of the magnetic body at the saddle point with the magnetization vector of the saddle point;
calculating, for each of the meshes, based on the tangential vector and the gradient vector, a velocity vector of the saddle point;
calculating, for each of the meshes, based on the magnetization vector of the saddle point and the velocity vector of the saddle point, a fluctuation amount in a predetermined time of the magnetization vector of the saddle point, a magnetization vector of the saddle point after the predetermined time, and a maximum of the fluctuation amount in all the meshes;
resetting, when the maximum is equal to or larger than a threshold, the magnetization vector of the saddle point after the predetermined time to the magnetization vector of the saddle point;
calculating a fluctuation amount in the predetermined time of the reset magnetization vector of the saddle point, a maximum in all the meshes of the fluctuation amount, and the reset magnetization vector of the saddle point after the predetermined time; and
outputting, when the maximum is smaller than the threshold, information concerning energy of the magnetic body and a magnetization vector of each of the meshes at the saddle point.

12. The magnetic body simulation method according to claim 11, wherein the transition path is a minimum energy path.

13. The magnetic body simulation method according to claim 11, further comprising:
displaying, on a display device, the information concerning the energy of the magnetic body and the magnetization vector of each of the meshes at the saddle point.

14. The magnetic body simulation method according to claim 13, wherein the processor displays, as an image, the magnetization vector of each of the meshes at the saddle point.

15. The magnetic body simulation method according to claim 11, further comprising:
outputting, to a design device, the information concerning the energy of the magnetic body and the magnetization vector of each of the meshes at the saddle point.
